(19) United States
(12) Patent Application Publication
(10) Pub. No.: US 2024/0021961 A1
(43) Pub. Date: Jan. 18, 2024

(54) BATTERY MODULE AND ELECTRONIC DEVICE USING THE SAME

(71) Applicant: Dongguan Poweramp Technology Limited, Dongguan (CN)

(72) Inventors: Feilong GUO, Dongguan (CN); Hongwei YUAN, Dongguan (CN)

(73) Assignee: Dongguan Poweramp Technology Limited, Dongguan (CN)

(21) Appl. No.: 18/478,311

(22) Filed: Sep. 29, 2023

Related U.S. Application Data
(63) Continuation of application No. PCT/CN2021/084750, filed on Mar. 31, 2021.

(51) Int. Cl. H01M 50/503; H01M 50/507; H01M 50/209; H01M 50/291

(52) U.S. Cl. CPC H01M 50/503; H01M 50/507; H01M 50/209; H01M 50/291

(57) ABSTRACT

A battery module including a battery unit and a conductive unit. The battery unit includes at least one cell, and each cell of the battery unit includes a first tab and a second tab having opposite polarities. The conductive unit includes a first conductive member and a second conductive member spaced apart from the first conductive member in a thickness direction of the cell, the first conductive member is electrically connected with the first tab of any cell, and the second conductive member is electrically connected with the second tab of any cell. The battery module is configured that the first conductive member and the second conductive member are in conductive contact through the swelling of the cell.

### CROSS-REFERENCE TO RELATED APPLICATION

The present application is a continuation application of PCT Application S.N. PCT/CN2021/084750, filed on Mar. 31, 2021, the content of which is incorporated herein by reference in its entirety.

### FIELD

The present application relates to the battery technology field, and in particular to a battery module and an electronic device using the same.

### BACKGROUND

With the continuous improvement of energy density and power density of battery modules, the safety problem of battery modules is becoming more and more prominent. For a single cell constituting a battery module, the cell usually expands with use time, which brings high safety risk to the use of battery modules.

### SUMMARY

In order to solve at least one problem existing in the prior art, the present application provides a battery module.

An embodiment of the present application provides a battery module, comprising a battery unit and a conductive unit. The battery unit includes at least one cell, and each cell includes a first tab and a second tab having opposite polarities. The conductive unit includes a first conductive member and a second conductive member spaced apart from the first conductive member in a thickness direction of the cell, the first conductive member is electrically connected with the first tab of any cell, and the second conductive member is electrically connected with the second tab of any cell.

In some embodiments of the present application, a resistance of the first conductive member is R1, and a resistance of the second conductive member is R2, 10 mΩ≤R1+R2≤10Ω.

In some embodiments of the present application, the first conductive member includes a first resistance part and a first connection part, and the first resistance part is connected with the first tab of any cell through the first connection part.

In some embodiments of the present application, the second conductive member includes a second resistance part and a second connection part, and the second resistance part is connected with the second tab of any cell through the second connection part.

In some embodiments of the present application, the at least one cell comprises at least two cells, the conductive unit is arranged between any two adjacent cells, and a projection of the first conductive member in the thickness direction and a projection of the second conductive member in the thickness direction at least partially overlap.

In some embodiments of the present application, the at least one cell includes a first cell, a second cell and a third cell, the first cell is arranged adjacent to the second cell, and the third cell is arranged adjacent to the second cell. The battery module further includes a third connection part and a fourth connection part electrically connected to the third connection part. In the thickness direction, the first conductive member and the third connection part are arranged between the first cell and the second cell, and the second conductive member and the fourth connection part are arranged between the third cell and the second cell. In the thickness direction, the projection of the first conductive part and a projection of the third connection part at least partially overlap, and projections of the second conductive part and the fourth connection part at least partially overlap.

In some embodiments of the present application, the battery module further includes a housing accommodating the battery unit.

In some embodiments of the present application, the battery module further includes a third connection part and a fourth connection part electrically connected to the third connection part. In the thickness direction, the battery unit includes a first end and a second end opposite to the first end, the first conductive member and the third connection part are arranged between the first end and the housing, and the second conductive member and the fourth connection part are arranged between the second end and the housing. In the thickness direction, the projection of the first conductive member and a projection of the third connection part at least partially overlap, and the projection of the second conductive member and a projection of the fourth connection part at least partially overlap.

In some embodiments of the present application, the at least one cell comprises at least two cells, and the battery module further includes a third connection part and a fourth connection part electrically connected to the third connection part. In the thickness direction, the battery unit includes a first end and a second end opposite to the first end, the first conductive member and the third connection part are arranged between the first end and the housing, or the first conductive member and the third connection part are arranged between the second end and the housing; the second conductive member and the fourth connection part are arranged between two adjacent cells. In the thickness direction, the projection of the first conductive member and a projection of the third connection part at least partially overlap, and projections of the second conductive member and the fourth connection part at least partially overlap.

In some embodiments of the present application, the third connection part and the fourth connection part are integrally formed.

In some embodiments of the present application, the first conductive member and the second conductive member are arranged between the battery unit and the housing, and stacked along the thickness direction.

In some embodiments of the present application, the battery module further includes a support member, and the first conductive member, the second conductive member and the support member are arranged between any two adjacent cells. In the thickness direction, the projection of the first conductive member and the projection of the second conductive member at least partially overlap, the support member has an annular projection, at least a part of the projection of the first conductive member falls in the annular projection, and at least a part of the projection of the second conductive member falls in the annular projection.

In some embodiments of the present application, the first conductive member is connected with a surface of one of the two adjacent cells, and the second conductive member is connected with a surface of the other of the two adjacent cells.

The present application further provides an electronic device, comprising any one of the above-mentioned battery modules.

In the battery module provided by the present application, the battery unit is provided with the first conductive member and the second conductive member, so that when the cell of the battery unit expands to a certain extent, the first conductive member and the second conductive member contact each other, so as to conduct at least one cell of the battery unit to form a parallel circuit. In this way, the battery unit discharges through the first conductive member and the second conductive member, thereby effectively reducing the safety risk of the battery module.

### BRIEF DESCRIPTION OF THE DRAWINGS

FIG. 1 is a structure diagram of a battery module in an embodiment of the present application.

FIG. 2 is a diagram of a partial structure of a battery module according to an embodiment of the present application.

FIG. 3 is an exploded view of a battery unit and a conductive unit of the battery module shown in FIG. 2.

FIG. 4 is a structure diagram of the first conductive member and the second conductive member shown in FIG. 3.

FIG. 5 is a circuit schematic diagram of an embodiment of the present application.

FIG. 6A is a schematic cross-sectional view of a first resistance part and a second resistance part shown in FIG. 1 along a line VI-VI in FIG. 4.

FIG. 6B is a schematic cross-sectional view of a first resistance part and a second resistance part in an embodiment of the present application.

FIG. 6C is a schematic cross-sectional view of a first resistance part and a second resistance part in an embodiment of the present application.

FIG. 7 is another structure diagram of a battery module in an embodiment of the present application.

FIG. 8 is a schematic cross-sectional view of a battery module according to an embodiment of the present application.

FIG. 9 is a structure diagram of a third connection part and a fourth connection part shown in FIG. 8.

FIG. 10 is a schematic cross-sectional view of a battery module according to an embodiment of the present application.

FIG. 11 is a schematic cross-sectional view of a battery module according to an embodiment of the present application.

FIG. 12 is a schematic cross-sectional view of a battery module according to an embodiment of the present application.

FIG. 13 is a structure block diagram of an electronic device according to the present application.

### REFERENCE NUMERALS OF MAIN ELEMENTS

Electronic device 1
Load 2
Battery module 100, 100a, 100b, 100c, 100d
Housing 10
Lower cavity body 101
Upper cap 102
Metal plug-in part 103
Through hole 104
Battery unit 20
Cell 21
First cell 21a
Second cell 21b
Third cell 21c
First tab 211
Second tab 212
Conductive unit 30
First conductive member 31
First resistance part 311
Convex surface 3111
Connector 3112
First connection part 312
Second conductive member 32
Second resistance part 321
Concave surface 3211
Matching member 3212
Second connection part 322
Third connection part 33
Fourth connection part 34
Surface 200
First surface 201
Second surface 202
Third surface 203
Support member 40
Adapter unit 50
Adapter board 51
First current collector 52
Second current collector 53
Collection wire 54
Colloidal body 70
First direction Z
Second direction X
Third direction Y

The following specific embodiments will further describe the present invention in combination with the above drawings.

### DETAILED DESCRIPTION

Hereinafter, referring to the accompanying drawings, the description for the contents of the present application will be more fully. Exemplary embodiments of the present application are shown in the accompanying drawings. However, the present application may be implemented in many different forms and should not be construed as limited to the exemplary embodiments set forth herein. These exemplary embodiments are provided to make the present application thorough and complete, and to fully convey the scope of the present application to those skilled in the art. Similar reference numerals denote the same or similar components.

The terms used herein are for the purpose of describing specific exemplary embodiments only and are not intended to limit the present application. As used herein, a singular form “a”, “one” and “this” are intended to also include a plural form unless the context clearly indicates otherwise. In addition, when used herein, “include” and/or “comprise” and/or “have”, integers, steps, operations, components and/or modules, but does not exclude the existence or addition of one or more other features, regions, integers, steps, operations, components, modules and/or groups thereof.

Unless otherwise defined, all terms (including technical and scientific terms) used herein have the same meaning as commonly understood by those skilled in the same art as the present application. In addition, unless explicitly defined herein, terms such as those defined in the general dictionary shall be interpreted as having meanings consistent with their meanings in the relevant technology and the contents of the present application, and will not be interpreted as idealized or too formal meanings.

Exemplary embodiments will be described hereinafter in conjunction with the accompanying drawings. It should be noted that the components depicted with reference to the drawings are not necessarily displayed in proportion. The same or similar components will be given the same or similar reference numerals or similar technical terms.

Hereinafter, the specific embodiments of the present application are described in further detail with reference to the accompanying drawings.

### Embodiment 1

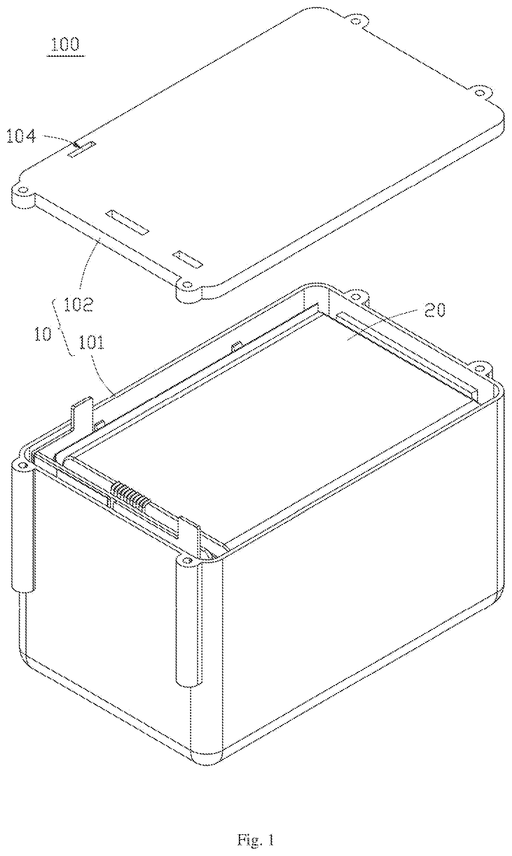

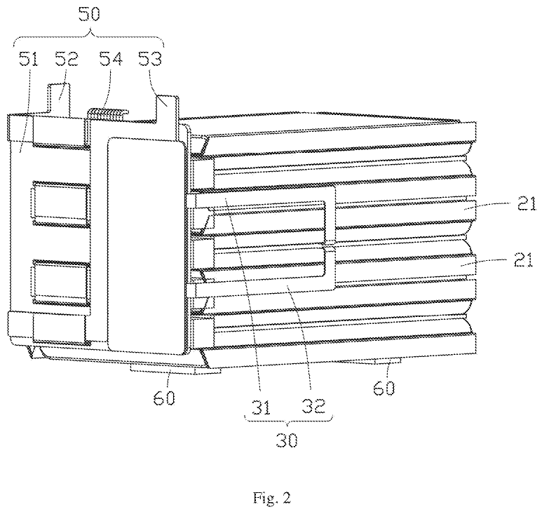

Referring to FIGS. 1 and 2, an embodiment of the present application provides a battery module 100. The battery module 100 includes a housing 10, a battery unit 20 and a conductive unit 30. The housing 10 includes a lower cavity body 101 and an upper cap 102. The lower cavity body 102 is configured to accommodate the battery unit 20 and the conductive unit 30, and the upper cap 102 covers the lower cavity body 101.

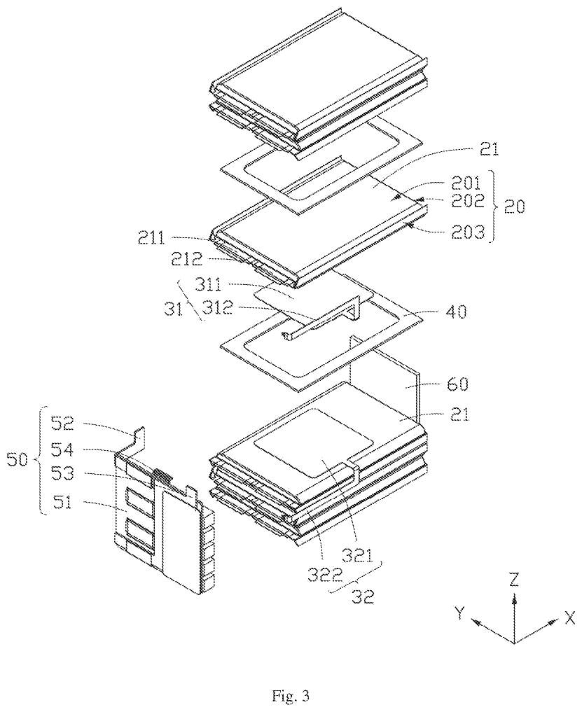

Referring to FIG. 3 together, in order to clearly describe each orientation hereinafter, a coordinate system is established to define each direction of the battery unit 20. A first direction Z is defined as a thickness direction of the cell 21, a second direction X is defined as a length direction of the cell 21, and a third direction Y is defined as a width direction of the cell 21. Exemplarily, the second direction X may be defined as the width direction of the cell 21, and the third direction Y may be defined as the length direction of the cell 21. Thereinto, the third direction Y is perpendicular to the second direction X in a horizontal plane, and the first direction Z is perpendicular to a plane formed by the second direction X and the third direction Y. Based on this definition of orientation, the description of the orientation or position relationship indicated by “upper”, “lower”, “top”, “bottom”, “front”, “back”, “inner”, “outer”, ect. is adopted, which is only for the convenience of describing the present application, rather than indicating or implying that the device must have a specific orientation, structure and operation in a specific orientation. Therefore, it cannot be understood as limiting the claimed scope of the present invention.

In this embodiment, the battery unit 20 includes at least one cell 21 stacked along the first direction Z. The cell 21 includes a first tab 211 and a second tab 212 having opposite polarities.

In this embodiment, the ends of each cell 21 provided the first tab 211 and the second tab 212 are located at the same end in the second direction X.

Exemplarily, the second direction X may be the same as an extension direction of the first tab 211 or the second tab 212. In some embodiments, the batteries 21 in the battery unit 20 are connected in series with each other.

Exemplarily, the batteries 21 in the battery unit 20 maybe connected in parallel. Exemplarily, a part of batteries 21 in the battery unit 20 can be connected in series to form several series battery packs, and several series battery packs are connected in parallel. In this way, the battery unit 20 forms a multiple connection battery pack.

The conductive unit 30 includes a first conductive member 31 and a second conductive member 32 spaced apart from the first conductive member 31 in the first direction Z. The first conductive member 31 is electrically connected with one of any first tab 211 or any second tab 212. The second conductive member 32 is electrically connected with the other of any first tab 211 or any second tab 212.

That is, the first conductive member 31 and the second conductive member 32 may be connected in parallel with any cell 21 in the battery unit 20. Moreover, exemplarily, the first conductive member 31 and the second conductive member 32 may be connected in parallel with any number of cells 21 in the battery unit 20. Moreover, exemplarily, the first conductive member 31 and the second conductive member 32 may be connected in parallel with the entire battery unit 20.

In an optional embodiment, a number of the at least one cell 21 in the battery unit 20 is at least two. The conductive unit 30 is arranged between any two adjacent batteries. And in the first direction Z, a projection of the first conductive member 31 and a projection of the second conductive member 32 at least partially overlap.

It can be understood that in one embodiment, in order to save a volume of the battery module 100, the first conductive member 31 is connected with a surface 200 of one of the two adjacent cells 21, and the second conductive member 32 is connected with a surface 200 of the other of the two adjacent batteries.

In order to clearly describe each orientation hereinafter, each face of the cell 21 is defined. The surface 200 of the cell 21 includes two first surfaces 201 that deviate from each other in the first direction Z, two second surfaces 202 that deviate from each other in the second direction X, and two third surfaces 203 that deviate from each other in the third direction Y.

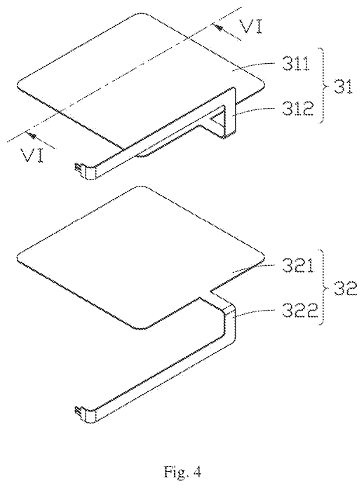

Referring to FIG. 4 together, the first conductive member 31 includes a first resistance part 311 and a first connection part 312. The first resistance part 311 is connected with one of any first tab 211 and any second tab 212 through the first connection part 312.

Thereinto, the first resistance part 311 is substantially in a sheet shape and is attached to the first surface 201 of one of the two adjacent cells 21.

Exemplarily, the first connection part 312 maybe substantially in a bent shape. The first connection part 312 extends for a distance along the first surface 201 where the first resistance part 311 is located, then bends, and extends along a third surface 203 of the same cell 21 in the direction where the first tab 211 and the second tab 212 are located.

The second conductive member 32 includes a second resistance part 321 and a second connection part 322. The second resistance part 321 is connected with the other of any first lug 211 and any second lug 212 through the second connection part 322.

Thereinto, the second resistance part 321 is substantially in a sheet shape and is attached to the first surface 201 of the other of the two adjacent cells 21.

Exemplarily, the second connection part 322 may be substantially in a bent shape. The second connection part 322 extends for a distance along the first surface 201 where the second resistance part 321 is located, then bends, and extends along the third surface 203 of the same cell 21 in the direction where the first tab 211 and the second tab 212 are located.

Referring to FIG. 3 again, in this embodiment, the battery module 100 further includes a support member 40. The support member 40 is arranged between any two adjacent cells 21, so as to reserve an expansion space having a preset distance for any two adjacent cells 21.

Exemplarily, the first conductive member 31, the second conductive member 32 and the support member 40 are arranged between any two adjacent cells 21. Both sides of the support member 40 are connected with the first conductive member 31 and the second conductive member 32 respectively. In the first direction Z, the projection of the first conductive member 31 and the projection of the second conductive member 32 at least partially overlap. The support member 40 has an annular projection, at least a part of the projection of the first conductive member 31 falls in the annular projection, and at least a part of the projection of the second conductive member 32 falls in the annular projection.

In the present embodiment, the support member 40 is substantially in an annular shape. Both sides of the support member 40 are respectively connected with the first connection part 312 and the second connection part 322, and both sides of the support member 40 are further respectively connected with the first surface 201 of two adjacent cells 21.

It can be understood that the support member 40 is made of insulating material and has a certain elasticity. For example, in an optional embodiment, the support member 40 is foam.

Exemplarily, the battery module 100 further includes an adapter unit 50. The adapter unit 50 may be configured to connect the battery unit 20 with other electronic components (not shown). The adapter unit 50 may further be configured to connect the battery unit 20 and the conductive unit 30.

Exemplarily, the adapter unit 50 includes an adapter board 51, a first current collector 52, a second current collector 53, and a collection wire 54. It can be understood that the adapter board 51, the first current collector 52, the second current collector 53 and the collection wire 54 are made of conductor material.

It can be understood that the adapter board 51 can be electrically connected to the battery unit 20 through the collection wire 54, so as to acquire a voltage of each cell 21 in the battery unit 20, and then manage a voltage output of each cell 21.

It can be understood that the battery unit 20 supplies power to other electronic components (not shown) through the first current collector 52 and the second current collector 53. Thereinto, the first current collector 52 and the second current collector 53 are electrically connected to the adapter board 51 respectively, and the first current collector 52 and the second current collector 53 have opposite polarities.

In this embodiment, the first tab 211 and the second tab 212 of the cell 21 are welded to the adapter board 51. The first connection part 312 and the second connection part 322 are further connected to pins of the adapter board 51, so as to electrically connect to the first tab 211 or the second tab 212 through the adapter board 51.

Exemplarily, the adapter board 51 may be a multilayer circuit printed board. In this way, the adapter board 51 is electrically connected with the first connection part 312, the second connection part 322 and the collection wire 59 through a via hole or a connecting finger.

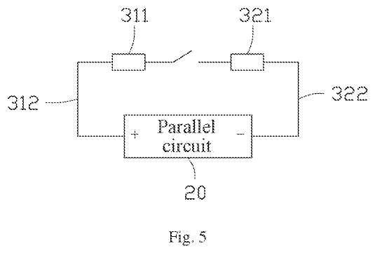

Referring to FIG. 5, it can be understood that the safety risk of the cell 21 of the battery unit 20 is low during normal use. When the cell 21 is used in extreme cases, such as continuing to use beyond a rated service life, or in some abuse cases, such as high temperature and high humidity, over charge and over discharge, or even continuing to use after the cell 21 is mechanically damaged, the risk of expansion of the cell 21 is high. When the expansion degree of the cell 21 is below a preset value, the first conductive member 31 and the second conductive member 32 spaced apart from each other (for example, the first resistance part 311 and the second resistance part 321 spaced apart from each other), which does not affect the normal use of the battery unit 20. When the cell 21 expands to a preset value, such as 10% of a preset expansion space, the first conductive member 31 and the second conductive member 32 attached to the first surface 201 of the two adjacent cells 21 contact each other (for example, the first resistance part 311 and the second resistance part 321 contact each other), and then they are connected in parallel with at least one cell 21 of the battery unit 20 to form a parallel circuit. In this way, the battery unit 20 reduces the safety risk of the battery module 100 by discharging to the first conductive member 31 and the second conductive member 32.

In this embodiment, a current when the battery unit 20 is discharged at a rate of 0.2 is defined as I1, a maximum allowable discharge current of the cell 21 in the parallel circuit is defined as I2, and a current of the parallel circuit is defined as I3, then I1<I3<I2.

It can be understood that I3>I1 can ensure that the power of the cell 21 in the parallel circuit can be quickly released when the first conductive member 31 is connected with the second conductive member 32, so as to improve the safety of the battery unit 20.

It can be understood that I3<I2 can ensure that the risk of excessive temperature of the battery unit 20 due to discharge is low when the first conductive member 31 is connected with the second conductive member 32, so as to reduce the safety risk of the battery unit 20.

In this embodiment, a resistance of the first conductive member 31 is defined as R1 and a resistance of the second conductive member 32 is defined as R2. The sum of the resistance values of the first conductive member 31 and the second conductive member 32 ranges from 10 milliohm to 10 ohm, that is, 10 mΩ≤R1+R2≤10Ω.

It can be understood that since heat dissipation of the cell 21 in a middle portion of the battery unit 20 is slow, the cell 21 with a large expansion degree is generally located in the middle portion of the battery unit 20, thus the conductive unit 30 can be arranged between two adjacent cells 21 that are in the middle portion of the battery unit 20.

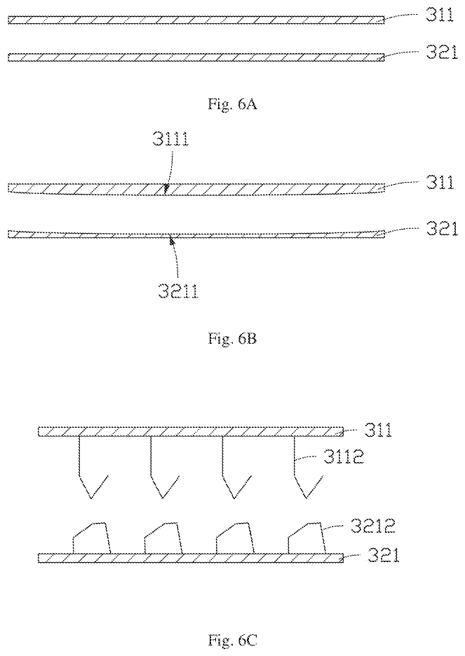

Referring to FIG. 6A, in this embodiment, both the first resistance part 311 and the second resistance part 321 may be substantially in a flat shape.

Referring to FIG. 6B, it can be understood that in an optional embodiment, the first resistance part 311 includes a convex surface 3111 and the second resistance part 321 includes a concave surface 3211. In this way, the first conductive member 31 and the second conductive member 32 are electrically connected through a connection between the convex surface 3111 and the concave surface 3211.

Referring to FIG. 6C, it can be understood that in an optional embodiment, the first resistance part 311 is provided with a connector 3112, and the second resistance part 321 is provided with a matching member 3212. In this way, the first conductive member 31 and the second conductive member 32 are electrically connected through a connection between the connector 3112 and the matching member 3212.

In an optional embodiment, the connector 3112 includes a hook, and the matching member 3212 includes an annular conductor wire.

Referring to FIGS. 2 and 3 together, in this embodiment, bottom and side of the battery unit 20 are further provided with cushion blocks 60 to provide angle protection for the battery unit 20, so as to reduce damages of the battery unit 20 under mechanical impact.

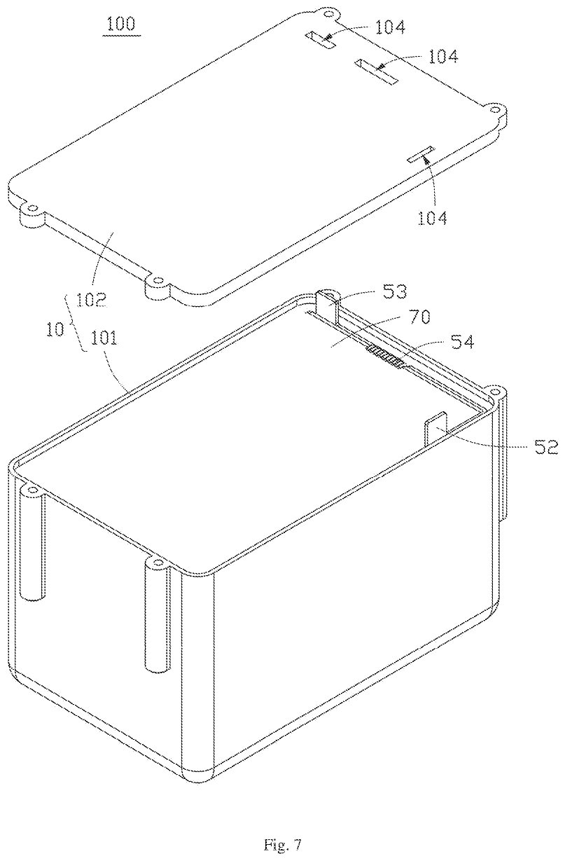

Referring to FIG. 7, in this embodiment, a colloidal body 70 can also be filled in the housing 10. It can be understood that the colloidal body 70 can be an insulating colloidal body for providing cooling, sealing and insulation protection for the battery unit 20.

It can be understood that in this embodiment, when the housing 10 is filled with the colloidal body 70, since the support member 40 is arranged between the two adjacent cells 21, the colloidal body 70 is isolated between the two adjacent cells 21, but will not affect the electrical connection between the first conductive member 31 and the second conductive member 32.

### Embodiment 2

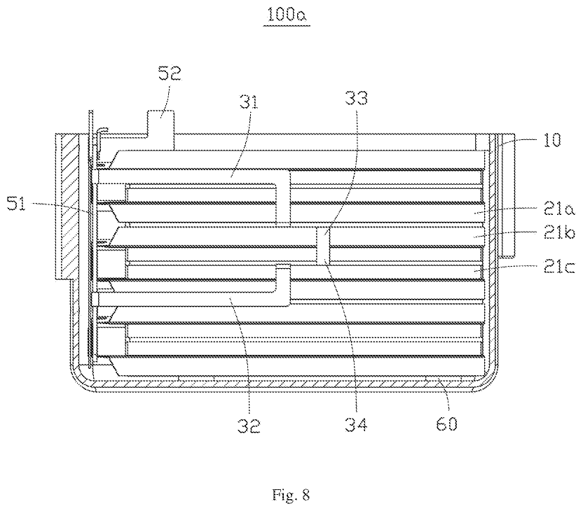

Referring to FIG. 8 together, Embodiment 2 of the present application provides a battery module 100a. The battery module 100a includes the housing 10, the battery unit 20, the conductive unit 30 and the support member 40.

In Embodiment 2, the difference between the battery module 100a and the battery module 100 in Embodiment 1 is that the number of at least one cell 21 is at least three, for example, including a first cell 21a, a second cell 21b and a third cell 21c. Thereinto, the first cell 21a is arranged adjacent to the second cell 21b, and the second cell 21b is arranged adjacent to the third cell 21c.

In the first direction Z, the first conductive member 31 is arranged between the first cell 21a and the second cell 21b. The second conductive member 32 is arranged between the second cell 21b and the third cell 21c.

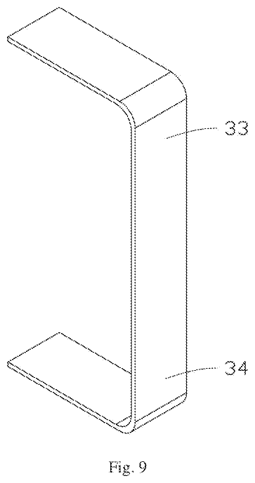

Referring to FIG. 9, the battery module 100a in Embodiment 2 is further different from the battery module 100 in Embodiment 1 in that the battery module 100a further includes a third connection part 33 and a fourth connection part 34 that are electrically connected. In this embodiment, both the third connection part 33 and the fourth connection part 34 can be substantially L-shaped sheets. Exemplarily, the third connection part 33 and the fourth connection part 34 may be integrally formed in a substantially C-shaped sheet.

Thereinto, in the first direction Z, the first conductive member 31 and the third connection part 33 are arranged between the first cell 21a and the second cell 21b. The second conductive member 32 and the fourth connection part 34 are arranged between the second cell 21b and the third cell 21c. In the first direction Z, the projection of the first conductive member 31 and a projection of the third connection part 33 at least partially overlap, and the projections of the second conductive member 32 and the fourth connection part 34 at least partially overlap.

That is, the first resistance part 311 and the third connection part 33 are arranged between the first cell 21a and the second cell 21b, and the first resistance part 311 and the third connection part 33 are respectively arranged on both sides of the support member 40. The second resistance part 321 and the fourth connection part 34 are arranged between the second cell 21b and the third cell 21c, and the second resistance part 321 and the fourth connection part 34 are respectively arranged on both sides of the support member 40.

In this way, when any cell 21 of the battery unit 20 expands, the first resistance part 311 is connected with the third connection part 33, and the second resistance part 321 is connected with the fourth connection part 34. That is, the first conductive member 31 and the second conductive member 32 are electrically connected through the third connection part 33 and the fourth connection part 34 to form a parallel circuit. In this way, the cell 21 connected in parallel to the parallel circuit in the battery unit 20 is discharged to the first conductive member 31 and the second conductive member 32, so as to reduce the safety risk of the battery module 100a.

Exemplarily, the housing 10 may not be filled with the colloidal body 70 or filled with other insulating materials. It should be noted that the filling of the insulating material should not affect the contact between the first conductive member 31 and the second conductive member 32.

### Embodiment 3

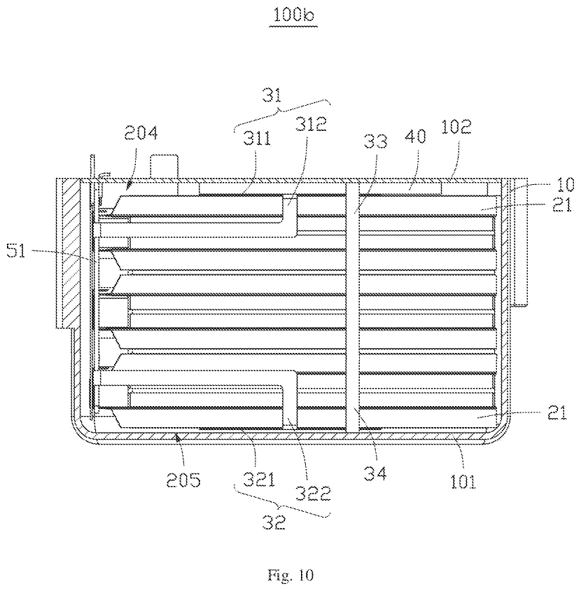

Referring to FIG. 10, Embodiment 3 of the present application further provides a battery module 100b. The battery module 100b includes the housing 10, the battery unit 20, the conductive unit 30, the third connection part 33, the fourth connection part 34 and the support member 40.

Thereinto, the battery unit 20 includes at least one cell 21.

Thereinto, in the first direction Z, the battery unit 20 includes a first end 204 and a second end 205 that are opposite.

It can be understood that a difference between the battery module 100b and the battery module 100a in Embodiment 2 is that the first conductive member 31 and the third connection part 33 are arranged between the first end 204 and the housing 10, and the second conductive member 32 and the fourth connection part 34 are arranged between the second end 205 and the housing 10.

In the first direction Z, the projection of the first conductive member 31 and the projection of the third connection part 33 at least partially overlap, and the projection of the second conductive member 32 and the projection of the fourth connection part 34 at least partially overlap.

Exemplarily, the housing 10 may include a lower cavity body 101 and an upper cap 102. It can be understood that the upper cap 102 is provided with a plurality of through holes 104 (see FIG. 1 or 7) for the first current collector 52, the second current collector 53 and the collection wire 54 to pass, so as to make them be exposed on the surface of the upper cap 102, thereby facilitating a connection of the battery module 100b with other electronic components.

That is, the first resistance part 311 and the third connection part 33 are arranged between the first end 204 and the upper cap 102. In addition, the first resistance part 311 is attached to the first surface 201 of the cell 21 which is at the top of the battery unit 20, and the third connection part 33 is attached to a side of the upper cap 102 close to the battery unit 20.

The second resistance part 321 and the fourth connection part 34 are arranged between the second end 205 and the lower cavity body 101. In addition, the second resistance part 321 is attached to the first surface 201 of the cell 21 which is at the bottom of the battery unit 20, and the first surface 201 is close to the lower cavity body 101. The fourth connection part 34 is attached to the side of the lower cavity body 101 close to the battery unit 20, or the fourth connection part is arranged on the first surface 201 of the cell 21 at the bottom of the battery unit 20, and the first surface 201 is close to the lower cavity body 101.

It can be understood that in Embodiment 3, the bottom of the battery unit 20 of the battery module 100b may not be provided with a cushion block 60.

It can be understood that the support member 40 is arranged between the first end 204 and the upper cap 102, in this way, both sides of the support member 40 are in contact with the first surface 201 of the cell 21 and the upper cap 102 respectively. The first conductive member 31 and the third connection part 33 are respectively connected with both sides of the support member 40. In the first direction Z, the projections of the third connection part 33 and the first resistance part 311 in the first direction Z at least partially overlap each other. The support member 40 has an annular projection, at least a part of the projection of the first conductive part falls in the annular projection, and at least a part of the projection of the third connection part 33 falls in the annular projection.

It is understood that the support member 40 is provided between the second end 205 and the lower cavity body 101. In this way, both sides of the support member 40 are in contact with the first surface 201 of the cell 21 and the lower cavity 101, respectively. The second conductive member 32 and the fourth connection part 34 are respectively connected with both sides of the support member 40. The projections of the fourth connection part 34 and the second resistance part 321 in the first direction Z at least partially overlap. The support member 40 has an annular projection, at least a part of the projection of the second conductive member 32 falls in the annular projection, and at least a part of the projection of the fourth connection part 34 falls in the annular projection.

In this way, when any cell 21 of the battery unit 20 expands, the first resistance part 311 is connected with the third connection part 33, and the second resistance part 321 is connected with the fourth connection part 34. That is, the first conductive member 31 and the second conductive member 32 are electrically connected through the third connection part 33 and the fourth connection part 34 to form a parallel circuit. In this way, the cell 21 connected in parallel to the parallel circuit in the battery unit 20 is discharged to the first conductive member 31 and the second conductive member 32, so as to reduce the safety risk of the battery module 100b.

Exemplarily, in this embodiment, the upper cap 102 may be provided with several colloid filling holes (not shown), so that the upper cap 102 first is covered on the lower cavity body 101, and then colloid is filled into the lower cavity body 101 through the colloid filling holes (not shown), which avoids that the colloidal body 70 generated by filling colloid first and then covering covers the first conductive member 31 and the third connection part 33, thereby affecting the conduction between the first conductive member 31 and the third connection part 33.

Exemplarily, the housing 10 may not be filled with colloid or filled with other insulating materials. It should be noted that the filling of the insulating material should not affect the contact between the first conductive member 31 and the second conductive member 32.

### Embodiment 4

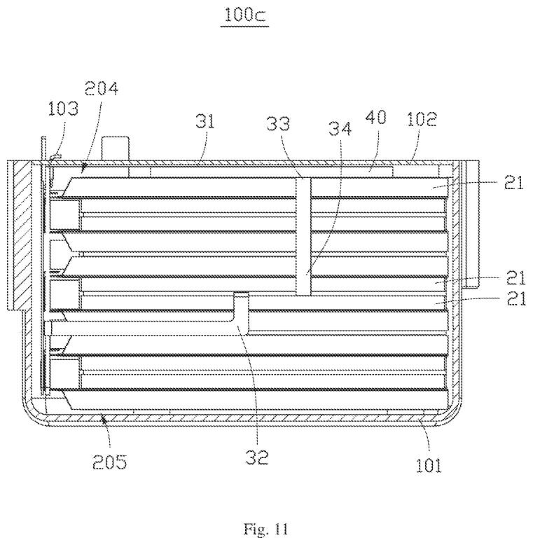

Referring to FIG. 11, Embodiment 4 of the present application further provides a battery module 100c. The battery module 100c includes the housing 10, the battery unit 20, the conductive unit 30, the third connection part 33, the fourth connection part 34 and the support member 40.

In the battery module 100c, the number of at least one cell 21 is at least two.

In the first direction Z, the battery unit 20 includes the first end 204 and the second end 205 that are opposite. The first conductive member 31 and the third connection part 33 are arranged between the first end 204 and the housing 10, or the first conductive member 31 and the third connection part 33 are arranged between the second end 205 and the housing 10. The second conductive member 32 and the fourth connection part 34 are arranged between two adjacent cells 21.

It can be understood that in this embodiment, a difference between the battery module 100c and the battery module 100b is that the second conductive part 32 and the fourth connection part 34 of the battery module 100c are arranged between two adjacent cells 21.

Exemplarily, the housing 10 includes the lower cavity body 101 and the upper cap 102.

In this embodiment, the first conductive member 31 is arranged on a side of the upper cap 102 close to the battery unit 20, and the third connection part 33 is arranged on a side of the battery unit 20 close to the upper cap 102. The second conductive member 32 and the fourth connection part 34 are arranged between two adjacent cells 21.

It can be understood that a metal plug-in part 103 can be provided on the upper cap 102, and the first conductive member 31 is connected to the metal plug-in part 103. The metal plug-in part 103 is used for electrically connecting with a corresponding pin on the adapter board 51 when the upper cap 102 is covered on the battery unit 20, so as to electrically connect the first conductive member 31 to one of the first tab 211 and the second tab 212 of the cell 21. It can be understood that the electrical connection mode of the second conductive member 32 to the first tab 211 or the second tab 212 is the same as that of the first conductive member 31 or the second conductive member 32 to the first tab 211 or the second tab 212 in Embodiment 1, which is not repeated herein.

The support member 40 is provided between the first conductive member 31 and the third connection part 33. The first conductive member 31 and the third connection part 33 are respectively connected with both sides of the support member 40. In the first direction Z, the projections of the first conductive part 31 and the third connection part 33 at least partially overlap, and the support member 40 has an annular projection, at least a part of the projection of the first conductive part 31 falls in the annular projection, and at least a part of the projection of the third connection part 33 falls in the annular projection.

It can be understood that when any cell 21 of the battery unit 20 expands, the first resistance part 311 is connected with the third connection part 33, and the second resistance part 321 is connected with the fourth connection part 34. That is, the first conductive member 31 and the second conductive member 32 are electrically connected through the third connection part 33 and the fourth connection part 34 to form a parallel circuit. In this way, the cell 21 connected in parallel to the parallel circuit in the battery unit 20 is discharged to the first conductive member 31 and the second conductive member 32, so as to reduce the safety risk of the battery module 100a.

It can be understood that in Embodiment 4, the arrangement mode of the first conductive part 31 and the third connection part 33 between the first end 204 and the housing 10 can also be the same as that of Embodiment 3. And in Embodiment 4, the arrangement mode of the first conductive member 31 and the third connection part 33 between the second end 205 and the housing 10 can also be the same as that of the second conductive member 32 and the fourth connection part 34 between the second end 205 and the housing 10 in Embodiment 3, which is not repeated herein.

It can be understood that in Embodiment 4, the arrangement mode of the second conductive member 32 and the fourth connection part 34 between two adjacent cells 21 is the same as that of the second conductive member 32 and the fourth connection part 34 between the second cell 21b and the third cell 21c in Embodiment 2, which is not repeated herein.

Exemplarily, in this embodiment, the upper cap 102 may be provided with several colloid filling holes (not shown), so that the upper cap 102 is first covered on the lower cavity body 101, and then colloid is filled into the lower cavity body 101 through the colloid filling holes (not shown), which avoids that the colloidal body 70 generated by filling colloid first and then covering covers the first conductive member 31 and the third connection part 33, thereby affecting the conduction between the first conductive member 31 and the third connection part 33.

Exemplarily, the housing 10 may not be filled with colloid or filled with other insulating materials. It should be noted that the filling of the insulating material should not affect the contact between the first conductive member 31 and the second conductive member 32.

### Embodiment 5

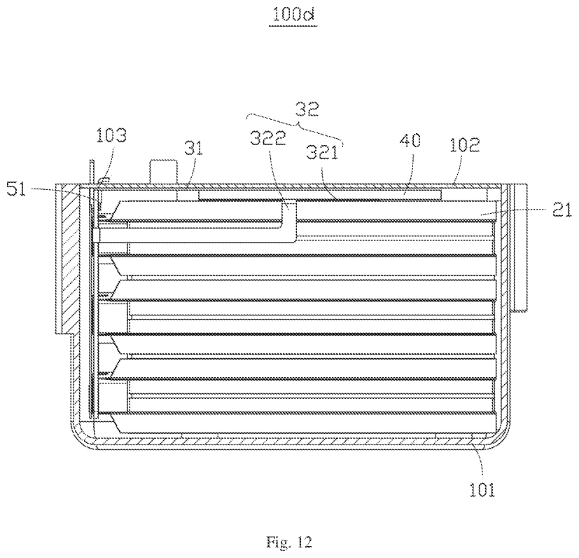

Referring to FIG. 12, Embodiment 5 of the present application further provides a battery module 100d. The battery module 100d includes the housing 10, the battery unit 20, the conductive unit 30 and the support member 40.

In the battery module 100d, the first conductive member 31 and the second conductive member 32 are arranged between the battery unit 20 and the housing 10, and the first conductive member 31 and the second conductive member 32 are stacked along the first direction Z.

A difference between the battery module 100d in Embodiment 5 and the battery module 100b is that the first both conductive member 31 and the second conductive member 32 in the battery module 100d are arranged between the battery unit 20 and the housing 10, and the first conductive member 31 and the second conductive member 32 are stacked along the first direction Z. Further, a difference between the battery module 100d and the battery module 100b is that the battery module 100d is not provided with a third connection part 33 and a fourth connection part 34.

Exemplarily, the housing 10 includes the lower cavity body 101 and the upper cap 102.

In this embodiment, the first conductive member 31 is arranged on a side of the upper cap 102 close to the battery unit 20, and the second conductive member 32 is arranged on a side of the battery unit 20 close to the upper cap 102. It can be understood that the metal plug-in part 103 can be provided on the upper cap 102, and the first conductive member 31 is connected to the metal plug-in part 103. The metal plug-in part 103 is used for electrically connecting with a corresponding pin on the adapter plate 51 when the upper cap 102 is covered on the battery unit 20, so as to electrically connect the first conductive member 31 to one of the first tab 211 and the second tab 212 of the cell 21. It can be understood that the electrical connection mode of the second conductive member 32 to the first tab 211 or the second tab 212 is the same as that of the first conductive member 31 or the second conductive member 32 to the first tab 211 or the second tab 212 in Embodiment 1, which is not repeated herein.

In this way, when any cell 21 of the battery unit 20 expands, the first resistance part 311 is connected with the second resistance part 321. That is, the first conductive member 31 is electrically connected with the second conductive member 32 to form a parallel circuit. In this way, the cell 21 connected in parallel to the parallel circuit in the battery unit 20 is discharged to the first conductive member 31 and the second conductive member 32, so as to reduce the safety risk of the battery module 100b.

It can be understood that the support member 40 is provided between the upper cap 102 and the battery unit 20. It can be understood that both sides of the support member 40 are connected with the first conductive member 31 and the second conductive member 32 respectively. In the first direction Z, the projections of the first conductive member 31 and the second conductive member 32 at least partially overlap. The support member 40 has an annular projection, at least a part of the projection of the first conductive member 31 falls in the annular projection, and at least a part of the projection of the second conductive member 32 falls in the annular projection.

It can be understood that the upper cap 102 of the battery module 100d may also be provided with colloid filling holes (not shown), so that the upper cap 102 first is covered on the lower cavity body 101, and then colloid is filled, which avoids that the colloidal body 70 covers the first conductive member 31 and the third connection part 33, thereby affecting the conduction between the first conductive member 31 and the third connection part 33.

Exemplarily, the first conductive member 31 may be arranged on a side of the lower cavity body 101 close to the battery unit 20, and the second conductive member 32 may be arranged on a side of the battery unit 20 close to the lower cavity body 101. It can be understood that the first conductive member 31 can be connected with the first tab 211 or the second tab 212 through the adapter board 51 by arranging a structure similar to the metal plug-in part 103 in the lower cavity body 101.

Exemplarily, the housing 10 may not be filled with colloid or filled with other insulating materials. It should be noted that the filling of the insulating material should not affect the contact between the first conductive member 31 and the second conductive member 32.

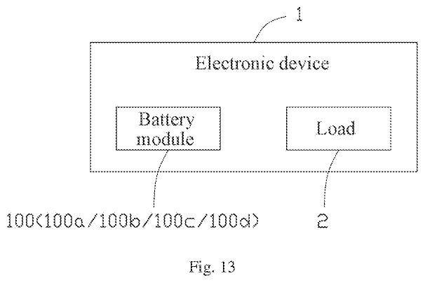

Referring to FIG. 13, an embodiment of the present application further provides an electronic device 1. The electronic device 1 includes the battery module 100 (100a/100b/100c/100d) and a load 2. The battery module 100 (100a/100b/100c/100d) is configured to supply power to the load 2. The electronic device 1 of the present application is not particularly limited, but can be used for any electronic device known in the prior art.

It should be emphasized that the above is only an embodiment of the present application and does not limit the present application in any form. Any simple modifications, equivalent changes and adjustments made to the above embodiments according to the technical essence of the present application belong to the claimed scope of the present application.

What is claimed is:

1. A battery module, comprising:
a battery unit comprising at least one cell, wherein each cell comprises a first tab and a second tab having opposite polarities; and
a conductive unit comprising a first conductive member and a second conductive member spaced apart from the first conductive member in a thickness direction of the cell, wherein the first conductive member is electrically connected with one of the first tab, and the second conductive member is electrically connected with one of the second tab;
wherein the first conductive member and the second conductive member are configured to be in conductive contact through the swelling of the at least one cell.

2. The battery module according to claim 1, wherein a resistance of the first conductive member is R1, a resistance of the second conductive member is R2, and 10 mΩ≤R1+R2≤10Ω.

3. The battery module according to claim 1, wherein the first conductive member comprises a first resistance part and a first connection part, and the first resistance part is connected with the one of the first tab through the first connection part.

4. The battery module according to claim 3, wherein the second conductive member comprises a second resistance part and a second connection part, and the second resistance part is connected with the one of the second tab through the second connection part.

5. The battery module according to claim 1, wherein the at least one cell comprises at least two cells, the conductive unit is arranged between two adjacent cells, and a projection of the first conductive member in the thickness direction and a projection of the second conductive member in the thickness direction at least partially overlap.

6. The battery module according to claim 1, wherein the at least one cell comprises a first cell, a second cell and a third cell; the first cell is arranged adjacent to the second cell, and the third cell is arranged adjacent to the second cell;
the battery module further comprises a third connection part and a fourth connection part electrically connected to the third connection part;
in the thickness direction, the first conductive member and the third connection part are arranged between the first cell and the second cell, and the second conductive member and the fourth connection part are arranged between the third cell and the second cell; and
in the thickness direction, the projection of the first conductive part and a projection of the third connection part at least partially overlap, and projections of the second conductive part and the fourth connection part at least partially overlap.

7. The battery module according to claim 1, further comprising a housing accommodating the battery unit.

8. The battery module according to claim 7, further comprising a third connection part and a fourth connection part electrically connected to the third connection part; wherein,
in the thickness direction, the battery unit includes a first end and a second end opposite to the first end, the first conductive member and the third connection part are arranged between the first end and the housing, and the second conductive member and the fourth connection part are arranged between the second end and the housing; and
in the thickness direction, the projection of the first conductive member and a projection of the third connection part at least partially overlap, and the projection of the second conductive member and a projection of the fourth connection part at least partially overlap.

9. The battery module according to claim 7, wherein the at least one cell comprises at least two cells;
the battery module further comprises a third connection part and a fourth connection part electrically connected to the third connection part;
in the thickness direction, the battery unit includes a first end and a second end opposite to the first end; the first conductive member and the third connection part are arranged between the first end and the housing, or the first conductive member and the third connection part are arranged between the second end and the housing; the second conductive member and the fourth connection part are arranged between two adjacent cells; and
in the thickness direction, the projection of the first conductive member and a projection of the third connection part at least partially overlap, and projections of the second conductive member and the fourth connection part at least partially overlap.

10. The battery module according to claim 6, wherein the third connection part and the fourth connection part are integrally formed.

11. The battery module according to claim 7, wherein the first conductive member and the second conductive member are arranged between the battery unit and the housing and stacked along the thickness direction.

12. The battery module according to claim 1, further comprising a support member; wherein the first conductive member, the second conductive member and the support member are arranged between two adjacent cells; and
in the thickness direction, the projection of the first conductive member and the projection of the second conductive member at least partially overlap, the support member has an annular projection, at least a part of the projection of the first conductive member falls in the annular projection, and at least a part of the projection of the second conductive member falls in the annular projection.

13. The battery module according to claim 12, wherein the first conductive member is connected with a surface of one of the two adjacent cells, and the second conductive member is connected with a surface of the other of the two adjacent cells.

14. An electronic device, comprising a battery module, wherein the battery module comprises:
a battery unit comprising at least one cell, wherein each cell comprises a first tab and a second tab having opposite polarities; and
a conductive unit comprising a first conductive member and a second conductive member spaced apart from the first conductive member in a thickness direction of the cell, wherein the first conductive member is electrically connected with one of the first tab, and the second conductive member is electrically connected with one of the second tab;
wherein the first conductive member and the second conductive member are configured to be in conductive contact through the swelling of the at least one cell.

15. The electronic device according to claim 14, wherein a resistance of the first conductive member is R1, a resistance of the second conductive member is R2, and 10 mΩ≤R1+R2≤10Ω.

16. The electronic device according to claim 14, wherein the first conductive member comprises a first resistance part and a first connection part, and the first resistance part is connected with the one of the first tab through the first connection part.

17. The electronic device according to claim 16, wherein the second conductive member comprises a second resistance part and a second connection part, and the second resistance part is connected with the one of the second tab through the second connection part.

18. The electronic device according to claim 14, wherein the at least one cell comprises at least two cells, the conductive unit is arranged between any two adjacent cells, and a projection of the first conductive member in the thickness direction and a projection of the second conductive member in the thickness direction at least partially overlap.

19. The electronic device according to claim 14, wherein the at least one cell comprises a first cell, a second cell and a third cell, the first cell is arranged adjacent to the second cell, and the third cell is arranged adjacent to the second cell;
the battery module further comprises a third connection part and a fourth connection part electrically connected to the third connection part;
in the thickness direction, the first conductive member and the third connection part are arranged between the first cell and the second cell, and the second conductive member and the fourth connection part are arranged between the third cell and the second cell; and
in the thickness direction, the projection of the first conductive part and a projection of the third connection part at least partially overlap, and projections of the second conductive part and the fourth connection part at least partially overlap.

20. The electronic device according to claim 14, wherein the battery module further comprises a support member, and the first conductive member, the second conductive member and the support member are arranged between any two adjacent cells; and
in the thickness direction, the projection of the first conductive member and the projection of the second conductive member at least partially overlap, the support member has an annular projection, at least a part of the projection of the first conductive member falls in the annular projection, and at least a part of the projection of the second conductive member falls in the annular projection.
